(19) United States
(12) Patent Application Publication
(10) Pub. No.: US 2009/0161507 A1
(43) Pub. Date: Jun. 25, 2009

(54) Infromation Recording/Reproducing Apparatus

(76) Inventors: Takaki MATSUSHITA, Yokohama (JP); Akinobu Watanabe, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/336,583

(22) Filed: Dec. 17, 2008

(30) Foreign Application Priority Data
Dec. 20, 2007 (JP) 2007-328580

(51) Int. Cl. G11B 7/00

(52) U.S. Cl. 369/47.5

(57) ABSTRACT

Provided is an information recording/reproducing apparatus which suppresses consumption of a battery and prevents wasteful power consumption in the case of failing in recording and dubbing operations, including a signal processor which processes video or audio elementary stream supplied from the outside; an encoding unit which compresses information generated by the signal processor; a first recording medium which records the information compressed by the encoding unit; a connection which connects an external first power source; an internal second power source which is different from the first power source; and a controller which, when detecting a writing failure of the compressed information in the first recording medium, stops a power supply from the second power source when a recording operation of the compressed information in the first recording medium is operated only by the second power source.

### INCORPORATION BY REFERENCE

The present application claims priority from Japanese application JP2007-328580 filed on Dec. 20, 2007, the content of which is hereby incorporated by reference into this application.

### BACKGROUND OF THE INVENTION

1. Field of the Invention

The present invention relates to an information recording/reproducing apparatus and a method of saving power thereof which is suitably applied to the information recording/reproducing apparatus in relation to power saving, particularly, in battery driving operation.

2. Description of the Related Art

There is disclosed a power-saving control method in which in a combination camera of an HDD (hard disk drive) and a DVD (digital versatile disk), an operation of an optical disk drive is stopped during a recording operation in a hard disk or an operation of a hard disk drive is stopped during a recording operation in an optical disk in battery driving operation. For this example, in JP-A-2006-286034, the above-described method is disclosed.

Further, there is disclosed a method in which in a video camera, a power saving mode is provided which is different from a power-on mode and a power-off mode and a battery is saved at the will of a photographer. For this example, in JP-A-2007-215246, the above-described method is disclosed.

### SUMMARY OF THE INVENTION

In recent years, products using, as a recording medium of a video camera, an HDD and an optical disk medium such as a DVD and a Blu-ray Disc, and further a flash memory such as an SD memory card go on the market. Products using, as a recording medium, an optical disk medium and a flash memory can easily bring out recorded contents and on the contrary, has disadvantages that a recording time is shorter than that of other media. On the other hand, a product using, as a recording medium, a large capacity HDD has a long recording time; however, the product is not used to bring out the contents from devices.

To redeem the above-described disadvantage, there is also considered, for example, a camera having mounted thereon both the HDD and the optical disk drive. By doing so, the recording operation can be performed in the HDD during the photographing for a long period of time and the recording operation can be performed in the optical disk in the case of bringing out contents from a device. Further, there can be provided the using method in which the contents are recorded in the HDD for a long period of time and dubbed to the optical disk, if necessary.

In a combination camera having mounted thereon both of the HDD and the optical disk drive, power consumption must be considered as compared with a camera having mounted thereon either the HDD or the optical disk drive. Since the camera is basically driven by a battery, when the drive units of both the HDD and the optical disk drive are operated, power consumption of the battery is high. In particular, when the dubbing operation is performed from the HDD to the optical disk, the drive units of both the HDD and the optical disk drive must be operated, and therefore, the power consumption of the battery is accelerated.

On the other hand, when the normal recording operation is performed in the optical disk medium or the dubbing operation is performed from the HDD to the optical disk medium, a defective writing is caused during the recording operation due to dusts adhering to the optical pickup and flaws or dusts adhering to the optical disk in some cases. Further, it is also considered that the defective writing is caused due to vibrations in the device such as a camera, which is carried by a user for use.

It is considered that in the case of the normal recording operation, generally, the user is always positioned near the camera in many times, and therefore, processing such as a replacement of media or re-recording operation can be immediately performed when the recording operation is stopped. When the contents that are recorded in the HDD for a long period of time are dubbed to the optical disk, it is as shown below depending on the performance of the optical disk drive. That is, the same amount of time as required for the recording operation of contents is required in many cases, or the dubbing time nearly twice that of contents in the dubbing source is also required, in some cases, when the encoding must be performed again. Therefore, there is a good chance that the user is away from the device, and even when failing in the dubbing operation due to the above-described fact, the user is not aware of the dubbing failure to continuously consume battery power.

In view of the foregoing, it is an object of the present invention to provide an information recording/reproducing apparatus and method of recording information which suppress consumption of the battery and prevent wasteful power consumption in the case of failing in the recording and dubbing operations.

To accomplish the above-described object, according to the present invention, there is provided an information recording/reproducing apparatus. The apparatus comprises:

a signal processor which processes video or audio elementary stream supplied from the outside;

an encoding unit which compresses information generated by the signal processor;

a first recording medium which records the information compressed by the encoding unit;

a connection which connects an external first power source;

an internal second power source which is different from the first power source;

a controller which, when detecting a writing failure of the compressed information in the first recording medium, stops a power supply from the second power source when a recording operation of the compressed information in the first recording medium is operated only by the second power source.

### BRIEF DESCRIPTION OF THE DRAWINGS

FIG. 1 is a block diagram illustrating a structure of an information recording/reproducing apparatus according to a first embodiment of the invention.

FIG. 2 is a block diagram illustrating a function of a controller according to the first embodiment.

FIG. 3 is a view illustrating a method of supplying power according to the first embodiment.

FIG. 4 is a flowchart showing a process in turning off power according to the first embodiment.

FIG. 5 is a flowchart showing a process during start-up according to the first embodiment.

FIG. 6 is a view showing a display example of a display unit according to the first embodiment.

FIG. 7 is a view showing a display example of a display unit according to the first embodiment.

FIG. 8 is a view showing a display example of a display unit according to the first embodiment.

FIG. 9 is a view showing a display example of a display unit according to the first embodiment.

FIG. 10 is a flowchart according to a second embodiment of the invention.

### DETAILED DESCRIPTION OF THE EMBODIMENTS

Hereinafter, embodiments according to the present invention will be described with reference to the accompanying drawings. In the embodiments described below, the case where an information recording/reproducing apparatus according to the present invention is applied to a video camera will be described; however, the present invention is not limited to the video camera. The present invention is applicable to a device for recording and reproducing video information or audio information, for example, as in a recorder having mounted thereon an HDD and a DVD.

### First Embodiment

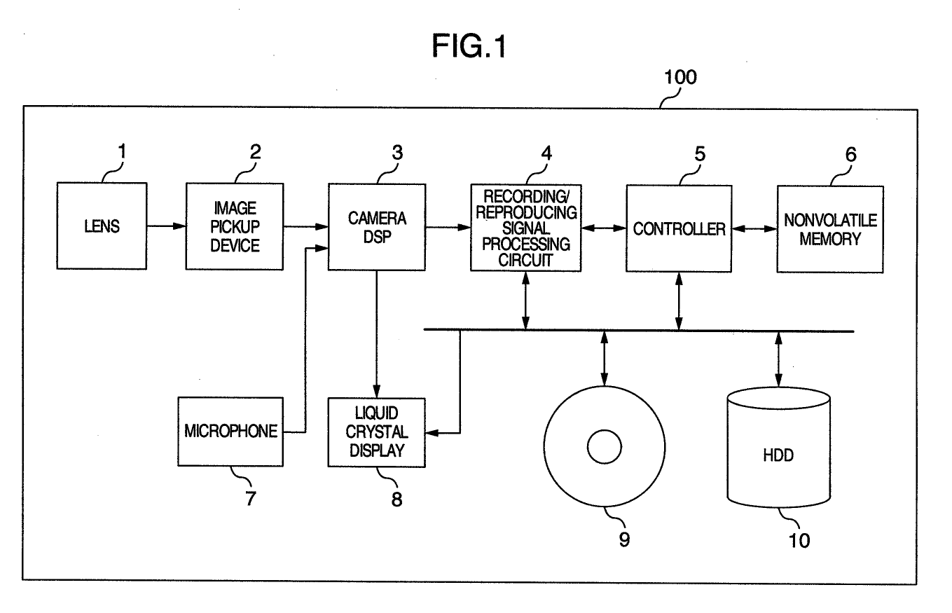

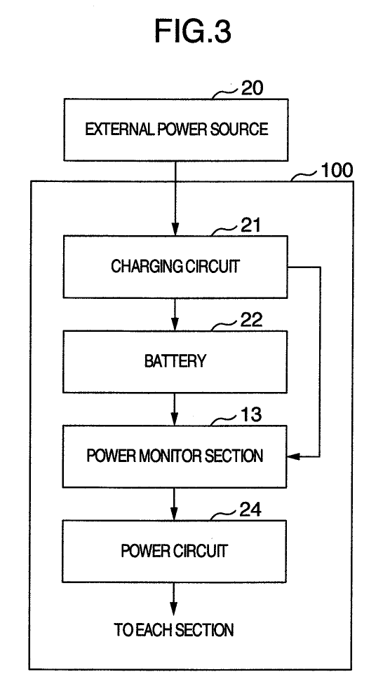

FIG. 1 shows a schematic structure of a video camera 100. The video camera 100 comprises a lens 1, an image pickup device 2, a camera DSP (digital signal processor) 3, a recording/reproducing signal processing circuit 4, a controller 5, a nonvolatile memory 6, a microphone 7, a liquid crystal display 8, an optical disk drive 9, and an HDD 10. The video camera 100 also has circuits related to the power source and a power source will be described below with reference to FIG. 3.

During a recording operation, a subject image taken in through the lens 1 is converted into video elementary stream by the image pickup device 2. The camera DSP 3 carries out processing of converting the video elementary stream into video data with a format treatable by the recording/reproducing signal processing circuit 4. In addition, the camera DSP 3 converts audio elementary stream supplied from the microphone 7 into audio data with a format treatable by the circuit 4.

The recording/reproducing signal processing circuit 4 performs compression encoding processing for recording audio and video data supplied from the camera DSP 3 in the HDD 10 or the optical disk medium such as a DVD or Blu-ray disc housed in the optical disk drive 9. Further, the circuit 4 also performs graphic drawing processing such as character information displayed on the liquid crystal display 8. Further, during the reproduction, the recording data reproduced from the HDD 10 or the optical disk drive 9 is decoded to the video data by the circuit 4. The decoded video data is displayed on the liquid crystal display 8 by the graphic drawing function.

The controller 5 comprises a control microcomputer that performs total control over the entire video camera 100. That is, the controller 5 performs control of each section within the above-described video camera 100 and a total management of the whole system. Specifically, the controller 5 manages a function of detecting a recording failure or dubbing failure in the HDD 10 and the optical disk drive 9, a function of reading/writing error information on a recording failure or dubbing failure in the nonvolatile memory 6, a function of restoring contents recorded in the HDD 10 or the optical disk media housed in the optical disk drive 9, and a timer function of timing a recording time and a system startup time.

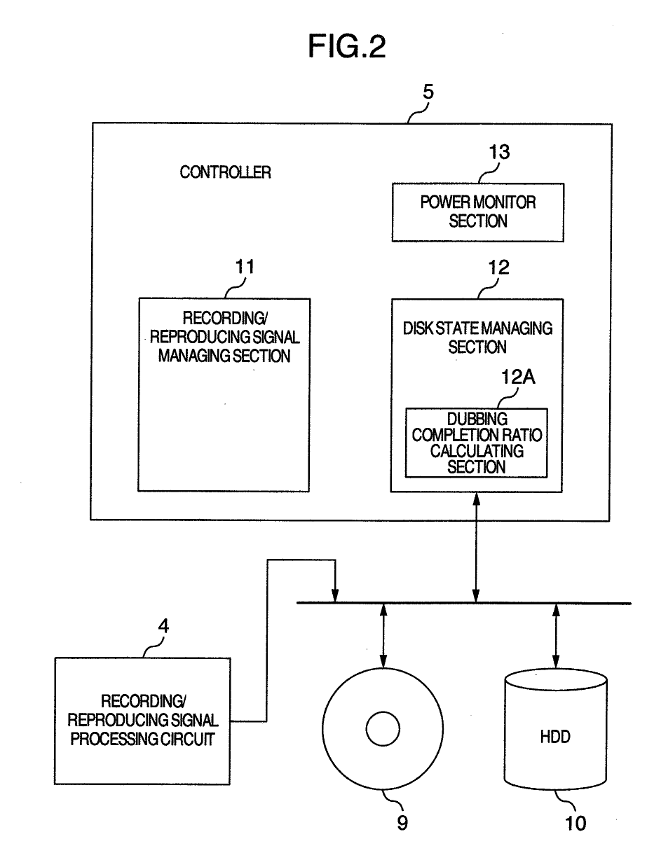

FIG. 2 illustrates a function of detecting the recording failure or dubbing failure and function of monitoring a power source, provided on the controller 5. The controller 5 has a recording/reproducing signal managing section 11, a disk state managing section 12, and a power monitor section 13. The disk state managing section 12 has a dubbing completion ratio calculating section 12A. This section 12A performs a processing for calculating a completion ratio of the dubbing operation, on an as needed basis, at the time of dubbing the predetermined contents recorded in the HDD 10 to the optical disk medium housed in the optical disk drive 9.

The recording/reproducing signal managing section 11 and the disk state managing section 12 detect the recording failure and the dubbing failure, respectively. The section 11 controls the recording/reproducing signal processing circuit 4. The section 12 controls the HDD 10 and the optical disk drive 9.

The recording/reproducing signal processing circuit 4 has a function of multiplexed video elementary stream and audio elementary stream to generate transport/program stream. The section 4 determines to be a writing error when a difference between the number of group of picture (GOP) of encoded video elementary stream and the number of the multiplexed GOP becomes larger than a predetermined number. The maximum of the difference in the GOP number is set to a level such that an overflow is prevented from occurring in a buffer provided on the inside of the circuit 4.

The disk state managing section 12 determines to be a writing error when write responses from the HDD 10 and the optical disk drive 9 exceed a predetermined time or more.

The power monitor section 13 monitors a state of the power source within the video camera 100. A function of monitoring this power source will be described in detail with reference to FIG. 3. FIG. 3 illustrates a flow of power supplied to the video camera 100.

Reference numeral 20 shown in FIG. 3 denotes an external power source, reference numeral 21 denotes a charging circuit, reference numeral 22 denotes a battery, reference numeral 13 denotes a power monitor section, and reference numeral 24 denotes a power circuit. When the power supply is performed from the external power source 20, the battery 22 is charged using the charging circuit 21.

When the power supply is performed from the external power source, power is supplied to the video camera 100 from the charging circuit 21 via the power circuit 24. When no power supply is performed from the external power source 20, the power is supplied to the video camera 100 from the battery 22 via the power circuit 24. The power monitor section 13 determines whether the video camera 100 operates either based on the power supplied from the external power source 20 or based on the power supplied from the battery 22.

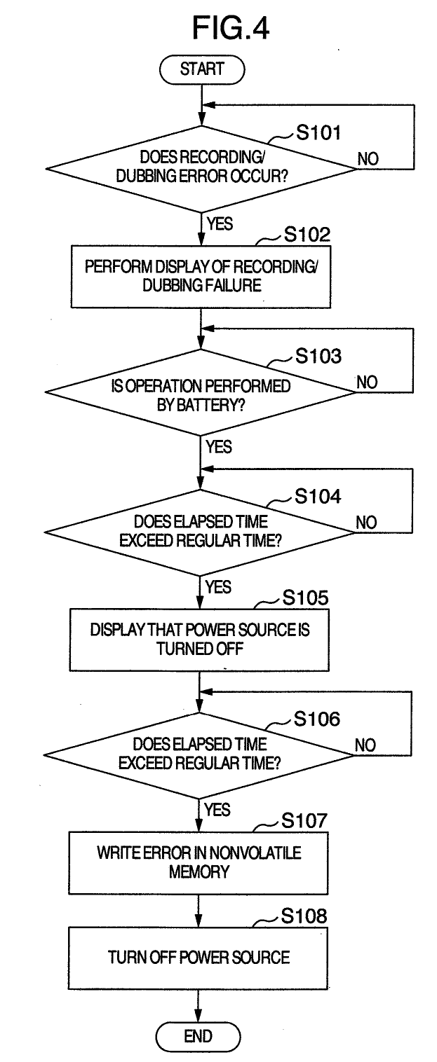

Next, the process to be performed by the controller 5 during the recording or dubbing operation will be described. FIG. 4 is a flowchart showing this process.

In step S101, the controller 5 determines whether an error occurs during the recording or dubbing operation. When the controller 5 does not determine that the error occurs (S101: NO), the recording or dubbing operation is continued. When determining that the error occurs (S101: YES), the controller 5 performs display processing of the recording or dubbing failure in step S102. This display processing is a processing for displaying on the liquid crystal display 8 a message informing a user of occurrence of errors and persuading the user to restart the system. Thereby, when the user is positioned near the video camera 100, measures such as performing the recording operation once more or performing the dubbing operation again can be taken after the restart by the display of this message.

Next, in step S103, the controller 5 determines based on the monitor results of the power monitor section 13 whether an operation is performed by the power supply from the battery 22. When the controller 5 does not determine that the operation is performed by the power supply from the battery 22, that is, the controller 5 determines that the operation is performed by the power supply from the external power source 20 (S103: NO), the process maintains the displayed state. Specifically, the process maintains the state where the error message is displayed on the liquid crystal display 8.

On the other hand, the controller 5, when determining that the operation is performed by the power supply from the battery 22 (S103: YES), determines whether the display time exceeds a certain period of time in step S104. Specifically, the controller 5 determines whether the error message display time exceeds a certain period of time. When the elapsed time does not satisfy the predetermined error message display time (S104: NO), the process maintains the state where the error message is displayed on the liquid crystal display 8. When the elapsed time exceeds the predetermined error message display time (S104: YES), the controller 5 displays on the liquid crystal display 8 a warning message showing that the power source is automatically turned off in step S105. A user's attention of the video camera 100 can be attracted by this warning message. This error message display time may be set by the user, or a fixed time such as ten minutes may be previously set.

The reason that the processing is categorized by types of power source as in the above-described steps S103 to S105 is as shown below. That is, when using the external power source like an AC adapter, the power supply is not stopped on the way unless the power supply service is interrupted. However, in the case of using the battery 22, when power consumption is reduced as much as possible, the apparatus can be used for long periods of time. Therefore, the apparatus is more user-friendly by categorizing the processing on the power source.

Next, in step S106, the controller 5 determines whether the elapsed time exceeds a certain period of time. When the controller 5 does not determine that the elapsed time exceeds the predetermined warning message display time (S106: NO), the process maintains the message display state. When determining that the elapsed time exceeds the predetermined warning message display time (S106: YES), the controller 5 writes information on the recording error or dubbing error in the nonvolatile memory 6 in step S107. Then, in step S108, the controller 5 switches off the battery 22 within the video camera 100.

When the recording failure or dubbing failure occurs through the above-described processing, it is not required to use wasteful power even if the user is not positioned near the video camera 100. Thereby, the power stored inside the battery 22 can be saved.

Meanwhile, during the occurrence of the recording error and dubbing error, when the power source is turned off through the processing, there is a good chance that the user cannot grasp success or failure in the desired recording operation or dubbing operation. In the case of performing the recording or dubbing operation particularly to the optical disk drive 9, when misunderstanding that the processing is successfully performed and ejecting the optical disk medium, the user is not aware of the recording failure or dubbing failure as long as the optical disk medium is not inserted into the optical disk drive 9 again. As a result, the above-described situation is unfavorable for the user. Therefore, when turning on the power source of the video camera 100, the user is preferably informed of the recording failure or dubbing failure at the time of being used immediately before.

Next, the process performed by the controller 5 during the start-up at the time when the video camera 100 is turned on will be described.

At first, in step S201, the controller 5 refers to the error information stored in the nonvolatile memory 6. Then, in step S202, the controller 5 determines whether the error exists. IN other words, the controller 5 determines whether the error information is stored in the nonvolatile memory 6. When not determining that the error information is stored in the nonvolatile memory 6 (S202: NO), the controller 5 performs the normal start in step S212.

When determining that the error information is stored in the nonvolatile memory 6 (S202: YES), the controller 5 determines whether contents shown by the error information contain the dubbing errors in step S203. The dubbing error is an error which occurs during the dubbing operation from the HDD to the optical disk. Further, when not containing the dubbing error, the contents shown by the error information contain an error at the time of the normal recording operation which occurs during the recording operation in the optical disk drive 9 or the HDD.

When determining that the error information contains the dubbing error in step S203 (S203: YES), the controller 5 displays on the liquid crystal display 8 the effect of failing in the dubbing operation and a query message whether the dubbing operation is retried in step S204. Thereby, the controller 5 can persuade the user to select whether the dubbing operation is retried. In step S205, the controller 5 deletes the error information stored in the nonvolatile memory 6.

Subsequently, in step S206, the controller 5 determines whether the dubbing operation is retried based on the instruction from the user against the query message displayed on the liquid crystal display 8. When determining that the dubbing operation is retried (S206: YES), the controller 5 performs the dubbing operation in step S207. Meanwhile, when not determining that the dubbing operation is retried (S206: NO), the controller 5 performs the normal start in step S212.

On the other hand, when determining that the error information contains an error during the normal recording operation (S203: NO), the controller 5 displays on the liquid crystal display 8 the effect of failing in the recording operation and the query message whether the restore processing is performed in step S208. Thereby, the controller 5 can persuade the user to select whether the restore processing is performed. Further, the controller 5 deletes the error information stored in the nonvolatile memory 6 in step S209.

In step S210, based on the instruction from the user against the query message displayed on the liquid crystal display 8, the controller 5 determines whether the recording data is restored. When determining that the recording data is restored (S210: YES), the controller 5 performs the restore processing of the recording data having completed therein the recording operation in step S211. Meanwhile, when not determining that the recording data is restored (S210: NO), the controller 5 performs the normal start in step S212. Since the restore processing is generally a processing requiring a certain amount of time, the controller 5 persuades the user to perform selection without automatically performing the restoration, thereby improving the usability of the video camera 100.

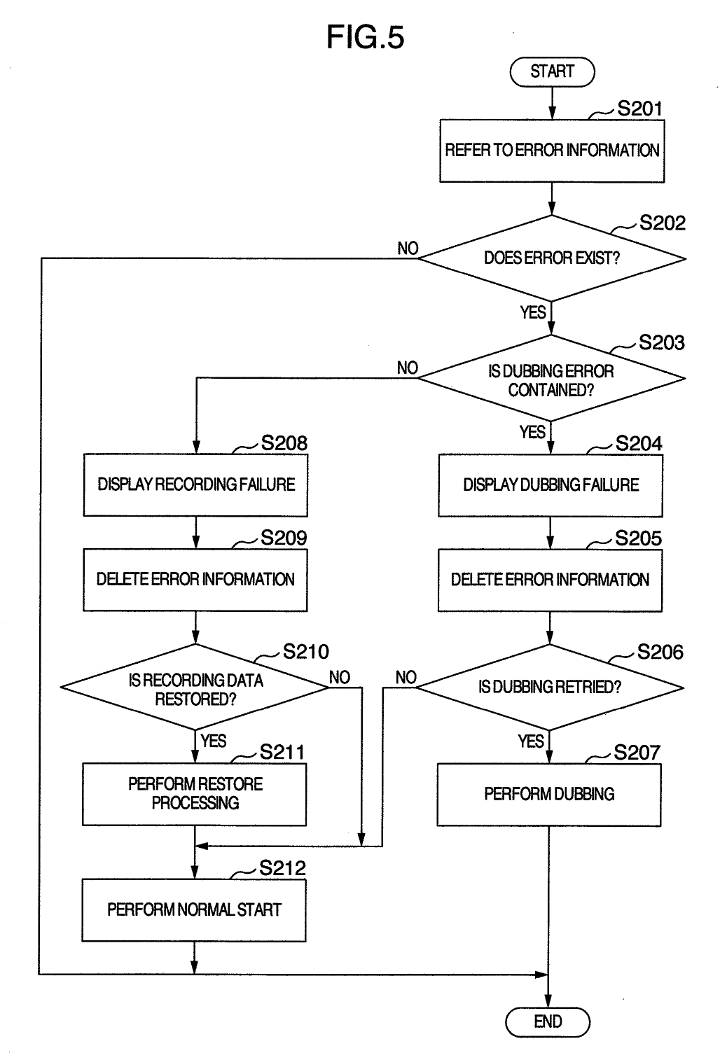

Suppose that when performing the process described above with reference to FIG. 5, the video camera 100 is turned off while the user does not take notice of the recording failure and the dubbing failure. Even in that case, the user is informed of error contents during the start-up, thereby coping with the recording failure and the dubbing failure.

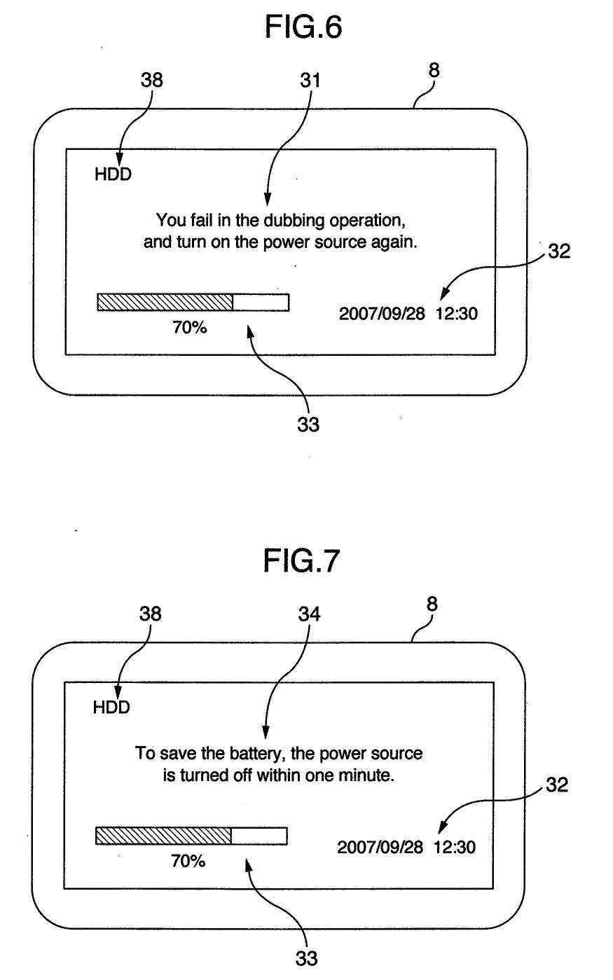

Next, with reference to FIGS. 6 to 9, there are shown examples of the messages displayed on the liquid crystal display 8 in steps S102, S105, S204, and S208. On the liquid crystal display 8, there are shown the message contents 31, 34, 35, and 37, other information sets 32 such as a recording mode and a photographing time (The other information sets 32 also include information 38 for displaying the recording media), the dubbing completion ratio 33 in the case of the dubbing failure, and the selection box 36 in the case of persuading the user to perform the selection.

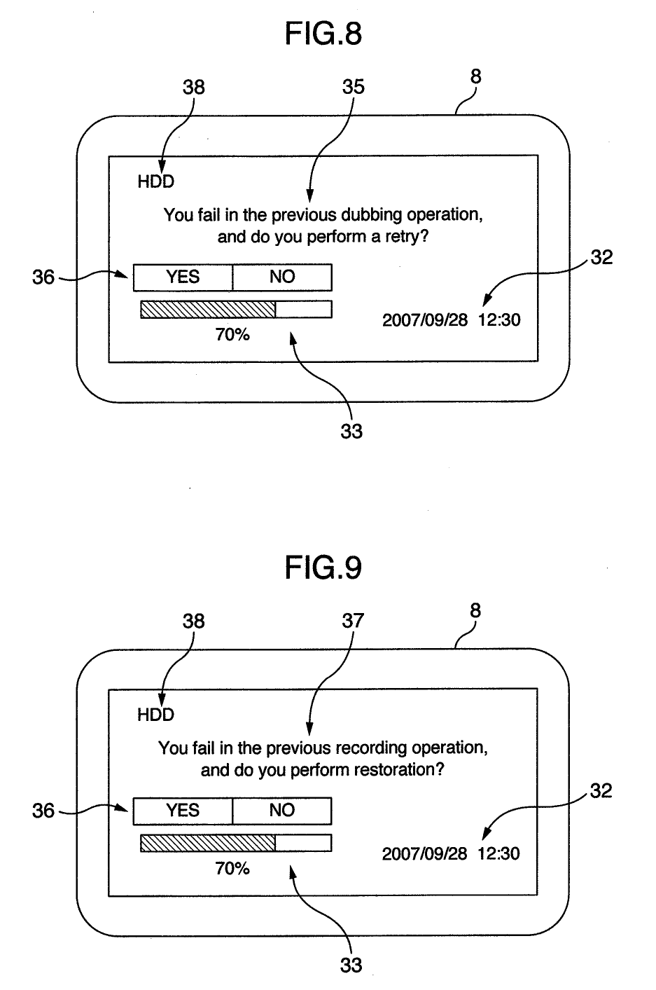

FIG. 6 shows the case where immediately after the user fails in the dubbing operation and expresses as the message contents 31 that “you fail in the dubbing operation, and turn on the power source again”. FIG. 7 shows the case where after the user fails in the dubbing operation, the elapsed time exceeds the predetermined time, and expresses as the message contents 34 that “to save the battery, the power source is turned off within one minute”. FIG. 8 shows the case where after restart of the system, the error information stored in the nonvolatile memory 6 exists, and expresses as the message contents 35 of the dubbing failure that “you fail in the previous dubbing operation, and do you perform a retry?” The user selects either “YES” or “NO” of the selection box 36. FIG. 9 shows the case where after the restart, the error information stored in the nonvolatile memory 6 exists. Further, FIG. 9 expresses as the message contents 37 of the normal recording failure that “you fail in the previous recording operation, and do you perform restoration?” The user selects either “YES” or “NO” of the selection box 36.

The reason that the dubbing completion ratio 33 is indicated is as shown below. That is, there is the possibility that when the dubbing operation is almost completed, a time period in the case where the restore processing is performed is shorter than a time period in the case where the dubbing operation is performed from the beginning again in the time required until the completion. Therefore, when the user determines either a makeup processing of the dubbing operation or a restore processing, the usability of the user becomes better.

According to the first embodiment, when the recording error or dubbing error described with reference to FIGS. 4 and 5 occurs, power saving control is performed with respect to the video camera 100. Thereby, even when the video camera 100 is left as it is while the recording and dubbing operations are continued, wasteful consumption of the power can be prevented.

When the recording error or the dubbing error occurs in the video camera 100, the messages described with reference to FIGS. 6 to 9 are expressed as a rule. When the above-described messages are displayed on the liquid crystal display 8, the user can immediately check the error contents when positioned near the video camera 100. Alternatively, also when the user is separated from the video camera 100 while leaving it as it is, power saving can be performed.

Suppose, for example, that the video camera 100 is turned off while the user is not aware of the recording failure and dubbing failure. Also in that case, the user can check the error contents during the start-up, and therefore, the effect of improving the usability of the user can be obtained.

The structure of the video camera 100 shown in FIGS. 1 and 2 according to the first embodiment, and the supply units of the power source shown in FIG. 3 are each just one example. An arrangement of the structure shown in FIGS. 1 to 3 is not limited thereto.

Further, a method of controlling the power during the occurrence of the recording or dubbing error, and transition of the processes shown in FIGS. 4 and 5 are each just one example; therefore, the process content is not limited thereto. The increase and decrease in the number of items of the process is neglected.

Further, the display information sets during the occurrence of the recording or dubbing error shown in FIGS. 6 to 9 are each just one example; therefore, the display content is not limited thereto. For example, messages set by the user may be displayed or only messages previously set by the developer may be used.

### Second Embodiment

Hereinafter, a second embodiment will be described. This second embodiment is an embodiment of the case where the video camera 100 according to the first embodiment is not equipped with the liquid crystal display 8, that is, the information recording/reproducing apparatus is not equipped with the display device. The power saving control which is different from that according to the first embodiment will be described below and the descriptions of the other portions will not be repeated.

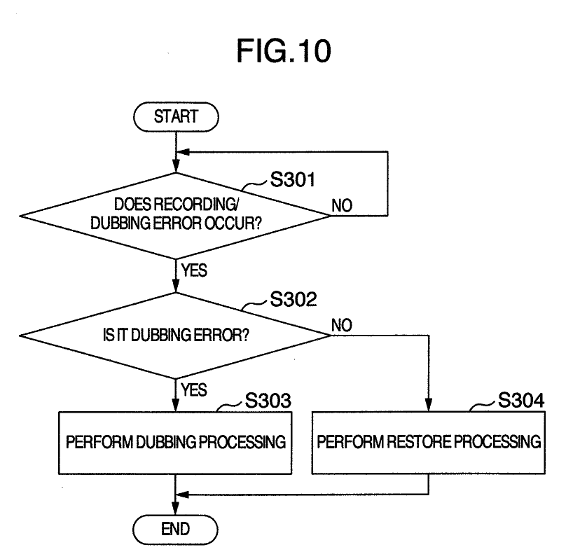

FIG. 10 is a flowchart showing the process of the power saving control according to the second embodiment. This processing is a processing performed during the recording or dubbing operation.

In step S301, the controller 5 determines whether the recording error or dubbing error occurs. When the controller 5 does not determine that the error occurs (S301: NO), the recording or dubbing operation is continued. When determining that the error occurs (S301: YES), the controller 5 determines whether the occurring error is a dubbing error in step S302. When determining that it is the dubbing error (S302: YES), the controller 5 performs the dubbing operation in step S303. Further, when the controller 5 does not determine that it is the dubbing error (S302: NO), that is, when the controller 5 determines that it is an error during the normal recording operation, it performs the restore processing up to the position where the recording operation is completed in the case where the error occurs during the normal recording operation in step S304.

According to the second embodiment, since the information recording/reproducing apparatus is not equipped with the display device, the controller cannot persuade the user to perform selection either that the dubbing operation is performed again or that the normal recording operation is performed. However, the user automatically performs restoration of the recording operation or performs a retry of the dubbing operation corresponding to errors when the errors occur. Thereby, the power saving control can be applied also to the inexpensive information recording/reproducing apparatus having no display device, and therefore, the usability of the user can be improved.

### Other Embodiments

In the above-described embodiments, there is described the case where the present invention is applied to the video camera 100 comprising:

the camera DSP 3 which processes video or audio elementary stream supplied from the outside;

the recording/reproducing signal processing circuit 4 which compresses information generated by the camera DSP 3;

the HDD 10 or the optical disk medium within the optical disk drive 9 which records the information compressed by the recording/reproducing signal processing circuit 4;

the charging circuit 21 which connects the external power source 20;

the battery 22; and

the controller 5 which, when detecting a writing failure of the compressed information in the HDD 10 or the optical disk medium within the optical disk drive 9, stops a power supply from the battery 22 when a recording operation of the compressed information in the HDD 10 or the optical disk medium within the optical disk drive 9 is operated only by the battery 22. However, the present invention is not limited to the above-described structure.

In the above-described embodiments, there is described the case where the present invention is applied to the video camera 100 comprising:

the camera DSP 3 which processes video or audio elementary stream supplied from the outside;

the recording/reproducing signal processing circuit 4 which compresses/expands information generated by the camera DSP 3;

the HDD 10 which records the information compressed by the recording/reproducing signal processing circuit 4;

the optical disk medium within the optical disk drive 9 which records the compressed information;

the charging circuit 21 which connects the external power source 20;

the battery 22; and

the controller 5 which, when detecting a writing failure of the compressed information in the optical disk medium within the optical disk drive 9, stops a power supply from the battery 22 when a reproducing operation of the compressed information recorded in the HDD 10 and recording operation of that recorded in the optical disk medium within the optical disk drive 9 by the recording/reproducing signal processing circuit 4 are operated at the same time only by the second power source. However, the present invention is not limited to the above-described structure.

According to the present invention, there is provided an information recording/reproducing apparatus which suppresses consumption of the battery and prevents wasteful power consumption in the case of failing in the recording and dubbing operations.

It should be further understood by those skilled in the art that although the foregoing description has been made on embodiments of the invention, the invention is not limited thereto and various changes and modification may be made without departing from the spirit of the invention and the scope of the appended claims.

1. An information recording/reproducing apparatus, comprising:
a signal processor which processes video or audio elementary stream supplied from an outside;
an encoding unit which compresses information generated by the signal processor;
a first recording medium which records the information compressed by the encoding unit;
a connection which connects an external first power source;
an internal second power source which is different from the first power source; and
a controller which, when detecting a writing failure of the compressed information in the first recording medium, stops a power supply from the second power source when a recording operation of the compressed information in the first recording medium is operated only by the second power source.

2. The information recording/reproducing apparatus according to claim 1, further comprising:
a second recording medium which is different from the first recording medium, wherein:
the controller, when detecting a writing failure in the first recording medium or/and the second recording medium, stops a power supply from the second power source when a recording operation in the first recording medium and that in the second recording medium are operated at the same time only by the second power source.

3. The information recording/reproducing apparatus according to claim 1, further comprising:
a display unit which displays information, wherein:
the controller, when detecting the writing failure, performs a display for calling a user's attention to the recording failure on the display unit.

4. The information recording/reproducing apparatus according to claim 1, wherein:
the controller, when detecting the writing failure, restores contents including the compressed information stored in the first recording medium.

5. The information recording/reproducing apparatus according to claim 1, further comprising:
a display unit which displays information; and
an error information storing unit which stores error information on the writing failure, wherein:
the controller performs the display on the display unit for persuading the user to restore the contents including the compressed data when the error information is stored in the error information storing unit during the start-up, and at the same time, contents shown by the error information include the writing failure in the case of being operated only by the second power source.

6. The information recording/reproducing apparatus according to claim 1, wherein:
the second power source is a battery.

7. The information recording/reproducing apparatus according to claim 2, wherein:
the first recording medium is any one of a hard disk, an optical disk, and a flash memory;
the second recording medium is any one of a hard disk, an optical disk, and a flash memory.

8. An information recording/reproducing apparatus, comprising:
a signal processor which processes video or audio elementary stream supplied from an outside;
a recording/reproducing signal processor which compresses/expands information generated by the signal processor;
a first recording medium which records the information compressed by the recording/reproducing signal processor;
a second recording medium which is different from the first recording medium that records the compressed information;
a connection which connects an external first power source;
an internal second power source which is different from the first power source; and
a controller which, when detecting a writing failure of the compressed information in the second recording medium, stops a power supply from the second power source when a reproducing operation of the compressed information recorded in the first recording medium and recording operation of that recorded in the second recording medium by the recording/reproducing signal processor are operated at the same time only by the second power source.

9. The information recording/reproducing apparatus according to claim 8, further comprising:
a display unit which displays information, wherein:
the controller, when detecting the writing failure, performs a display for calling a user's attention to the recording failure on the display unit.

10. The information recording/reproducing apparatus according to claim 8, wherein:
the controller, when detecting the writing failure, performs the reproduction operation of the compressed data recorded in the first recording medium and the recording operation of the data in the second recording medium again.

11. The information recording/reproducing apparatus according to claim 8, further comprising:
a display unit which displays information; and
an error information storing unit which stores error information on the writing failure, wherein:
the controller performs the display on the display unit for persuading the user to perform the reproducing operation and the recording operation again when the error information is stored in the error information storing unit during the start-up, and at the same time, the contents shown by the error information include the writing failure in the case of being operated only by the second power source, as well as in the case where the reproducing operation from the first recording medium and the recording operation in the second recording medium are operated at the same time.

12. The information recording/reproducing apparatus according to claim 8, wherein:
the second power source is a battery.

13. The information recording/reproducing apparatus according to claim 8, wherein:
the first recording medium is any one of a hard disk, an optical disk, and a flash memory;
the second recording medium is any one of a hard disk, an optical disk, and a flash memory.
